(19) United States
(12) Patent Application Publication
(10) Pub. No.: US 2017/0332723 A1
(43) Pub. Date: Nov. 23, 2017

(54) LIGHTED FOOTWEAR DEVICE

(71) Applicant: Kevin Caldwell, Simi Valley, CA (US)

(72) Inventor: Kevin Caldwell, Simi Valley, CA (US)

(21) Appl. No.: 15/601,907

(22) Filed: May 22, 2017

Related U.S. Application Data
(60) Provisional application No. 62/339,948, filed on May 22, 2016.

(51) Int. Cl. A43B 3/00; F21V 23/02; F21V 23/00; A43B 13/36; A43B 1/00; A43B 1/10; F21V 23/04; A43C 15/02; F21Y 2113/10; F21Y 2115/10

(52) U.S. Cl. CPC A43B 3/001; F21V 23/04; F21V 23/02; F21V 23/003; A43C 15/02; A43B 13/36; A43B 1/0072; A43B 1/10; F21Y 2115/10; F21Y 2113/10

(57) ABSTRACT

A lighted footwear device for use with existing footwear is disclosed herein comprising: a toe section, a heel section, a pair of adjustable strap members, and a plurality of light members. The plurality of light members are each attached to an outer surfaces of one of the toe section and the heel section. Each of the plurality of light members includes a pressure switch adapted to light up the light member when pressure is applied thereto and turn off when the light member is relieved of the pressure, such that when a person wearing the footwear walks or runs upon a surface respective lights will emit light when stepped upon. The lighted footwear device is adapted to be releasably attached to outer surfaces of respective toe and heel sections of the footwear.

### CROSS-REFERENCE TO RELATED APPLICATION

The present application is related to and claims priority from prior provisional application Ser. No. 62/339,948, filed May 22, 2016 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of footwear devices and more specifically relates to a lighted footwear device comprising distinctive and colorful LED lights located on an outer sole that are activated by a step of a user thereby providing the user with enjoyment of colorfully personalizing the footwear, but will also allow a user who is out at night walking, bicycling, or jogging more visible to motorists.

### 2. Description of the Related Art

Although the sneaker is a relatively modern invention, its roots go deeper than we might imagine—deeper, in fact, than many of the sports in which sneakers are worn. Before the late 19th century every individual shoe was produced by hand. By the late 1800s, with newly invented materials like vulcanized rubber and new production methods like assembly lines, shoes could be manufactured cheaply and in large quantities, and because shoes were inexpensive, the growing population of workers could afford them. While the early 20th century witnessed the birth of many of today's familiar sneaker brands including Keds, Converse, and Adidas, sneakers mostly remained the footwear of competing athletes, until Hollywood picked up on the fashion: first in the 1930's and then again in the 1950's when teen icon James Dean was photographed wearing jeans, a t-shirt, and sneakers. From then on, these cheap, durable shoes became part of the official uniform of kids around the world.

In 1985, basketball legend Michael Jordan joined with Nike to release the Air Jordan®, a sophisticated and expensive basketball shoe, and the modern era of sneakers had begun. Today's sneakers are high-tech, high-dollar shoes designed for almost any activity you can name, from running to basketball to tennis to walking, and the shoes are so highly valued by youth that people have lost their lives over a pair of sneakers. Recent innovations in sneakers have included skate-wheels embedded in the soles, pneumatic bladders that can be pumped up to increase shock-absorption, and price tags that used to be associated with handmade Italian mountain boots. The market for athletic footwear is staggeringly large; and in such a market, there is always room for innovation and creativity. The next big design in a vibrant, dynamic market where creating a trend can mean a huge financial return. An exciting, new accessory for sneakers and other shoes as well, is needed for such a trend.

Various attempts have been made to solve problems found in rest stands art. Among these are found in: U.S. Pat. No. 5,857,273 to Carmen C. Rapisarda; U.S. Pat. No. 4,020,572 to Gasper Chiaramonte, Jr.; and U.S. Pat. No. 5,771,611 to Chung-Tang Chang. This prior art is representative of lighted footwear. None of the above inventions and patents, taken either singly or in combination, is seen to describe the invention as claimed.

Ideally, a lighted footwear device (also referred to herein as Steplights) should be user-friendly and safe in-use and, yet should operate reliably and be manufactured at a modest expense. Thus, a need exists for lighted footwear device comprising distinctive and colorful LED lights located on an outer sole that are activated by a step of a user thereby providing the user with enjoyment of colorfully personalizing the footwear, but will also allow a user who is out at night walking, bicycling, or jogging more visible to motorists and to avoid the above-mentioned problems

### BRIEF SUMMARY OF THE INVENTION

In view of the foregoing disadvantages inherent in the known footwear devices art, the present invention provides a lighted footwear device (also referred to herein as Steplights). The general purpose of the present invention, which will be described subsequently in greater detail is to provide a lighted footwear device comprising distinctive and colorful LED lights located on an outer sole that are activated by a step of a user thereby providing the user with enjoyment of colorfully personalizing the footwear, but will also allow a user who is out at night walking, bicycling, or jogging more visible to motorists.

A lighted footwear device for use with existing footwear is disclosed herein comprising: a toe section, a heel section, a pair of adjustable strap members, and a plurality of light members. The toe section is adapted to be releasably attached to a toe portion of the existing footwear. The heel section is adapted to be releasably attached to a heel portion of the existing footwear. The pair of adjustable strap members are connected between the toe section and the heel section on opposite sides thereof, such that a distance between the toe section and the heel section can be adjusted to the size of the footwear. The plurality of light members are each attached to an outer surfaces of one of the toe section and the heel section. Each of the plurality of light members includes a pressure switch adapted to light up the light member when pressure is applied thereto and turn off when the light member is relieved of the pressure, such that when a person wearing the footwear walks or runs upon a surface respective lights will emit light when stepped upon. The lighted footwear device is adapted to be releasably attached to outer surfaces of respective toe and heel sections of the footwear.

The present invention holds significant improvements and serves as a lighted footwear device. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, Lighted Footwear Device (Steplgihts), constructed and operative according to the teachings of the present invention.

FIG. 1 shows a perspective view illustrating a lighted footwear device in an in-use condition according to an embodiment of the present invention. (Show user wearing footwear with the footwear being illuminated)

FIG. 2 is a perspective view illustrating a Lighted Footwear Device according to an embodiment of the present invention of FIG. 1. (FIG. 3 IN BROCHURE)

FIG. 3 is a front perspective view illustrating the Lighted Footwear Device according to an embodiment of the present invention of FIG. 1. (FIG. 1 IN BROCHURE)

FIG. 4 is a back perspective view illustrating Lighted Footwear Device according to an embodiment of the present invention of FIG. 1. (FIG. 2 IN BROCHURE)

The various embodiments of the present invention will hereinafter be described in conjunction with the appended drawings, wherein like designations denote like elements.

### DETAILED DESCRIPTION

As discussed above, embodiments of the present invention relate to footwear devices and more specifically relates to a lighted footwear device (Steplights) comprising distinctive and colorful LED lights located on an outer sole that are activated by a step of a user thereby providing the user with enjoyment of colorfully personalizing the footwear, but will also allow a user who is out at night walking, bicycling, or jogging more visible to motorists.

Generally speaking, the Steplights would be a slip-on, removable rubber outer sole appropriate for use by children or adults for use on various types of footwear and which features toe-and-heel colored LED lights that turn on and off with the wearer's step. The Steplights would be produced in a range of sizes for wearers ranging from toddlers to pre-teens and teens, to adults. Both the toe and heel regions will be equipped with a grooved border that accommodates and slips securely over the outersoles, and heel-cups, of the wearer's existing shoes. The top of the Steplights heel-cup will also feature a handy pull-tab, making it easy to put the Steplights on or take them off.

The Steplights would be fabricated in a tough and durable, translucent rubber or synthetic rubber, and the soles would consist of a forward portion underlying the toes and ball of the foot; a rear portion underlying the heel; and a pair of stout, stretchable rubber straps which join the heel and toe components. The Steplights would be a slip-on, removable rubber outersoles—appropriate for use by any youngster or adult, and with both sneakers and other types of footwear, which feature toe-and-heel, colorful LED lights that turn on and off according to the wearer's step.

The soles or bottoms of both the toe and heel components would be molded with treads, bumps, or lugs to provide good traction when walking. The Steplights would be fabricated in a tough and durable, translucent rubber or synthetic rubber, and the soles would consist of a forward portion underlying the toes and ball of the foot; a rear portion underlying the heel; and a pair of stout, stretchable rubber straps which join the heel and toe components. The soles or bottoms of both the toe and heel components would be molded with treads, bumps, or lugs to provide for good traction when walking. The Steplights would be produced in a range of sizes for wearers ranging from toddlers to pre-teens and teens, to adults. Both the toe and heel regions will be equipped with a grooved border that accommodates and slips securely over the outersoles, and heel-cups, of the wearer's existing shoes. The top of the Steplights heel-cup will also feature a handy pull-tab, making it easy to put the Steplights on or take them off. To put the Steplight on, one would simply insert the toe of one's shoe into the toe-groove of the Steplight; then pull back on the heel-cup pull-tab until the heel of the shoe is fully covered by the heel of the Steplight, and pull up on the pull-tab to set the Steplight securely in place over the sole of the shoe.

The Steplights would be powered by batteries of unspecified number and cell-type—likely one AA-cell, or two AAA-cells per sole, and the battery compartments would likely be snap-sealing, and built into the side of the heels. These batteries will power an array of bright and colorful LEDs (Light-Emitting Diodes): one set in the front of the toe section, with two on either side of the toe section; as well as one at the back of the heel section and two more on either side of the heel. These LEDs will be activated by pressure-switches, such that they come on and go off rhythmically in the course of walking. One additional design consideration here might be to include, on the side of the Steplight heel, a toggle switch permitting the user to select not only the pressure-activated, walking mode, but also a continuous mode and a flashing mode—as these would not only offer variety but might also appeal to the varied needs of such users as walkers, hikers, and cyclists. Another design consideration would be to offer not only the basic Steplights, but also an accessory set of interchangeable, colored, snap-in lenses for the LEDs—again, offering consumers greater variety within the same basic product.

The Steplights, then, would offer light-hearted consumers of any age a delightful, novel, and expressive footwear accessory—one sure to catch the attention of onlookers and passersby. Easy to put on and take off, and designed to flash with every step taken, the Steplights would be the perfect footwear accessory for parties and dance-clubs, and great for holidays, with red and green lights (or LED lenses) at Christmas, for example, orange at Halloween. The steplights would be for consumers who walk, jog, run, or bicycle at night for exercise or transportation, and would function as a high-visibility safety device, turning their sneakers into caution lights that approaching motorists could see. The steplights would provide a good grip and secure fit with not only sneakers but other shoes as well. The Steplights would also be eminently affordable, in essence providing the user a new pair of shoes at a fraction of the price. For all these reasons, the Steplights clever in conception, thoughtful in design, and conceived to please consumers of all ages and both sexes—should find a wide and exceptionally enthusiastic reception in the footwear markets of America and the world.

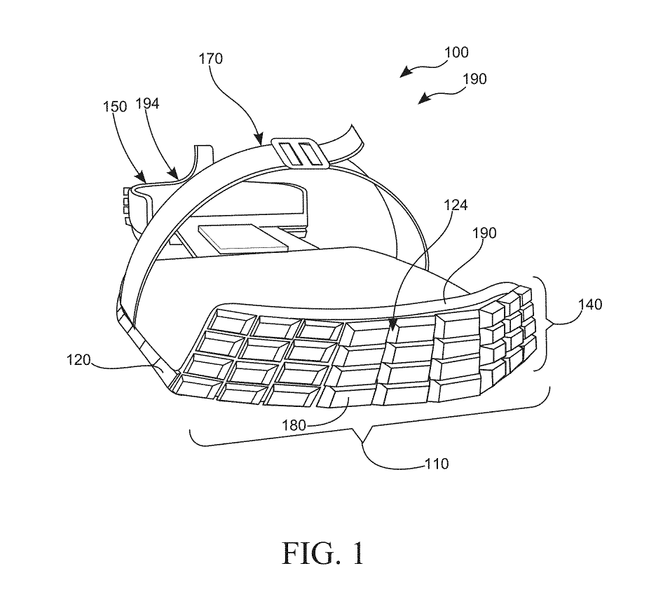

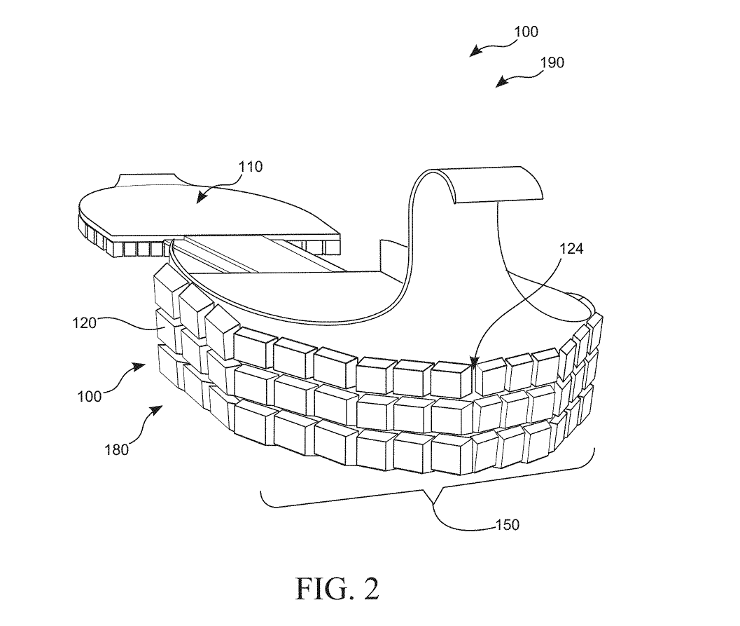

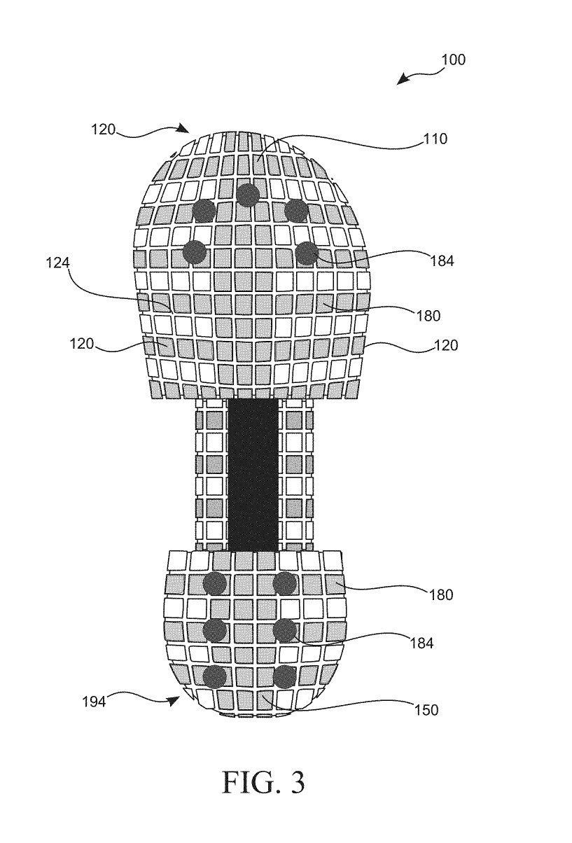

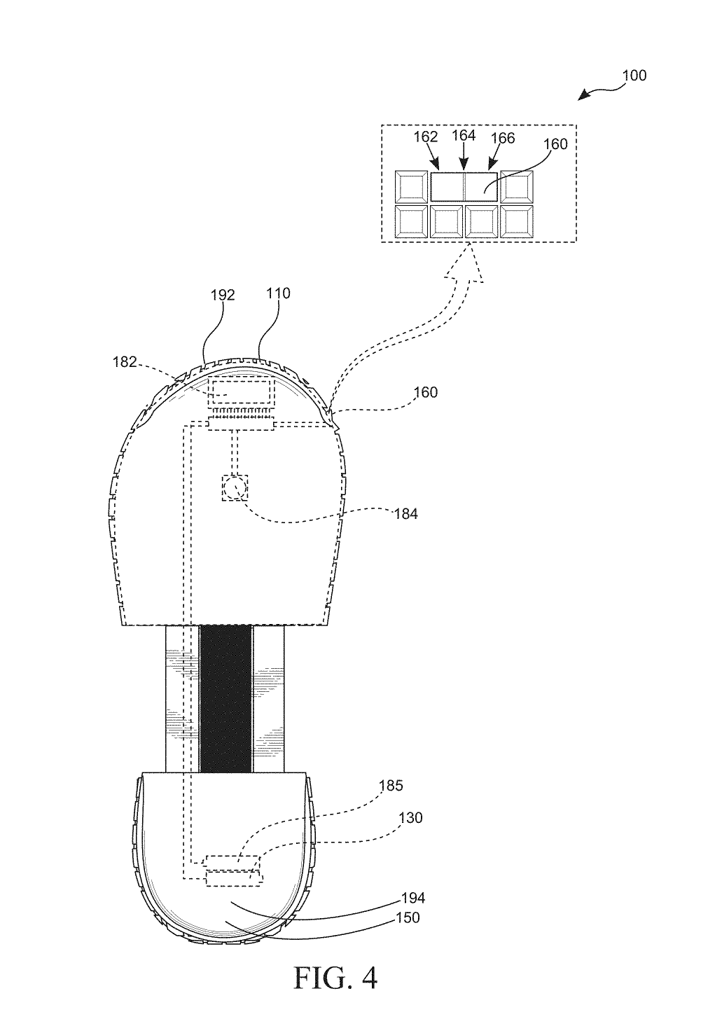

Referring now to FIGS. 1-4, showing perspective views illustrating lighted footwear device 100 according to an embodiment of the present invention of FIG. 1.

Lighted footwear device 100 for use with existing footwear 190 is disclosed herein comprising: toe section 110, heel section 150, pair of adjustable strap members 170, and plurality of light members 180. Toe section 110 is adapted to be releasably attached to toe portion 192 of existing footwear 190. Heel section 150 is adapted to be releasably attached to heel portion 194 of existing footwear 190. Lighted footwear device 100 is adapted to be releasably attached to outer surfaces of respective toe 192 and heel section 194 of footwear 190.

Toe section 110 and heel section 150 may be formed from a translucent rubber material or a synthetic rubber material. Toe section 110 and heel section 150 each include border member 120 extending therefrom adapted to grip respective outer surfaces of toe 192 and heel section 194 of footwear 190. Border member 120 includes grooved portion 124 along a length thereof adapted to increase the friction between toe section 192 and footwear 190 and heel section 194 each and footwear 190. Heel section 150 further include tab member 154 extending therefrom and adapted to allow a user to pull heel section 150 away from toe section 110 to more easily attach or remove lighted footwear device 100 from footwear 190.

Pair of adjustable strap members 170 are connected between toe section 110 and heel section 150 on opposite sides thereof, such that a distance between toe section 110 and heel section 150 can be adjusted to the size of footwear 190. Pair of adjustable strap members 170 are formed of a resilient material adapted to be stretched out under a tensional force and return to its original shape when relieve of the tensional force. The resilient material is rubber. Upon reading this specification, it should be appreciated that, under appropriate circumstances, considering such issues as user preferences, design preference, structural requirements, marketing preferences, cost, available materials, technological advances, etc., other material arrangements such as, for example, soft plastic, neoprene, etc., may be sufficient.

Plurality of light members 180 are each attached to outer surfaces of one of toe section 110 and heel section 150. Each of plurality of light members 180 includes pressure switch 184 adapted to light up light member 180 when pressure is applied thereto and turn off when light member 180 is relieved of the pressure, such that when a person wearing footwear 190 walks or runs upon a surface respective lights will emit light when stepped upon. Light members 180 are formed as light emitting diodes. Plurality of light members 180 emit light chosen from a list of light colors consisting of red, orange, yellow, green, blue, and violet.

Lighted footwear device 100 further comprising power source 130 embedded within each of toe section 110 and heel section 150 and electronically connected to each plurality of light members 180 thereon. Power source 130 is formed as a battery member. .Each of toe section 110 and heel section 150 further include plurality of tread members 140 on bottom surfaces thereof. Plurality of tread members 140 are formed as tread members chosen from a list of tread members consisting of bumps, lugs, and elongated ridges.

Lighted footwear device 100 further comprising computer circuit member 182 embedded within each of toe section 110 and heel section 150 and electronically connected to each plurality of light members 180 thereon. Computer circuit member 182 is adapted to control when plurality of light members 180 light up or when they are turned off. Computer circuit members 182 are adapted to control plurality of light members 180 to light up in series of modes chosen from a list of modes consisting of pressure mode 162, continuous mode 164, and flashing mode 166. Lighted footwear device 100 further comprising toggle switch 160 upon a side portion of each of toe section 110 and heel section 150 and electronically connected to each computer circuit member 120 to thereby provide manual control of series of modes.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A lighted footwear device for use with existing footwear, comprising:
a toe section:
wherein said toe section is adapted to be releasably attached to a toe portion of said existing footwear;
a heel section:
wherein said heel section is adapted to be releasably attached to a heel portion of said existing footwear;
a pair of adjustable strap members;
wherein said pair of adjustable strap members are connected between said toe section and said heel section on opposite sides thereof, such that a distance between said toe section and said heel section can be adjusted to the size of said footwear; and
a plurality of light members;
wherein said plurality of light members are each attached to an outer surfaces of one of said toe section and said heel section; and
wherein each of said plurality of light members includes a pressure switch adapted to light up said light member when pressure is applied thereto and turn off when said light member is relieved of said pressure, such that when a person wearing said footwear walks or runs upon a surface respective lights will emit light when stepped upon;
wherein said lighted footwear device is adapted to be releasably attached to outer surfaces of respective toe and heel sections of said footwear.

2. The lighted footwear device of claim 1, wherein said pair of adjustable strap members are formed of a resilient material adapted to be stretched out under a tensional force and return to its original shape when relieve of said tensional force.

3. The lighted footwear device of claim 2, wherein said resilient material is rubber.

4. The lighted footwear device of claim 1, wherein said light members are formed as light emitting diodes.

5. The lighted footwear device of claim 1, wherein said toe section and said heel section are formed from a translucent rubber material.

6. The lighted footwear device of claim 1, wherein said toe section and said heel section are formed from a synthetic rubber material.

7. The lighted footwear device of claim 1, wherein said toe section and said heel section each include a border member extending therefrom adapted to grip respective said outer surfaces of said respective toe and heel sections of said footwear.

8. The lighted footwear device of claim 7, wherein each said border member includes a grooved portion along a length thereof adapted to increase the friction between said toe section and said footwear and said heel section each and said footwear.

9. The lighted footwear device of claim 1, wherein said heel section further include a tab member extending therefrom and adapted to allow a user to pull said heel section away from said toe section to more easily attach or remove said lighted footwear device from said footwear.

10. The lighted footwear device of claim 1, further comprising a computer circuit member embedded within each of said toe section and said heel section and electronically connected to each said plurality of light members thereon; and wherein said computer circuit member is adapted to control when said plurality of light members light up or when they are turned off.

11. The lighted footwear device of claim 1, further comprising a power source embedded within each of said toe section and said heel section and electronically connected to each said plurality of light members thereon.

12. The lighted footwear device of claim 11, wherein said power source is formed as a battery member.

13. The lighted footwear device of claim 1, wherein each of said toe section and said heel section further include a plurality of tread members on bottom surfaces thereof.

14. The lighted footwear device of claim 13, wherein said plurality of tread members are formed as tread members chosen from a list of tread members consisting of bumps, lugs, and elongated ridges.

15. The lighted footwear device of claim 13, wherein said plurality of light members emit light chosen from a list of light colors consisting of red, orange, yellow, green, blue, and violet.

16. The lighted footwear device of claim 10, wherein said computer circuit members are adapted to control said plurality of light members to light up in series of modes chosen from a list of modes consisting of a pressure mode, a continuous mode, and a flashing mode.

17. The lighted footwear device of claim 16, further comprising a toggle switch upon a side portion of each of said toe section and said heel section and electronically connected to each said computer circuit member to thereby provide manual control of said series of modes.
